(19) United States
(12) Patent Application Publication
(10) Pub. No.: US 2005/0194891 A1
(43) Pub. Date: Sep. 8, 2005

(54) Organic light-emitting diode display device with a function of converting to be mirror

(76) Inventors: Yi-Chu Wu, Hualien County (TW); Wen-Jui Liao, Taichung County (TW); Chung-Hui Hu, Yunlin County (TW)

Correspondence Address: BIRCH STEWART KOLASCH & BIRCH, PO BOX 747, FALLS CHURCH, VA, 22040-0747, US

(21) Appl. No.: 10/790,745

(22) Filed: Mar. 3, 2004

(51) Int. Cl. H05B 33/00

(52) U.S. Cl. 313/504; 313/112

(57) ABSTRACT

An organic light-emitting diode display device according the present invention includes a metal electrode layer, an organic light-emitting diode layer, a phase transforming film and a polarizer. The phase transforming film has a retardation state of a quarter-wave phase difference that can be converted to have a retardation state with zero phase difference. The arrangement of the phase transforming film and polarizer can eliminate interference from reflecting light off the organic light-emitting diode layer when the organic light-emitting diode layer itself emits light, and can have a function of converting the organic light-emitting diode display device to be a mirror when the organic light-emitting diode layer does not emit light.

### FIELD OF THE INVENTION

The present invention relates to an organic light-emitting diode display device, and more particularly to an organic light-emitting diode display device with a function of converting to be a mirror.

### BACKGROUND OF THE INVENTION

In order to eliminate the light reflection of a metal electrode layer, a typical organic light-emitting diode display device is provided with a quarter-wave film (¼ λfilm) and a polarizer which are mounted on an organic light-emitting diode layer in sequence. The optical properties of the quarter-wave film and the polarizer are utilized to eliminate the light reflection on the metal electrode layer.

A conventional display device with a function of converting to be a mirror is mainly constituted by a liquid crystal display, provided with a twisted nematic cell attached to the liquid crystal display and having a dual brightness enhancement film (DBEF), such that the display device with a function of converting to be a mirror is completed. However, the utilization rate of the conventional display devices are not good, cost is increased, and the transmittance rate of the conventional display device is less than 9% therefore there are still difficulties with brightness.

FIG. 1 depicts a conventional organic light-emitting diode display device. The conventional organic light-emitting diode display device includes an organic light-emitting diode layer 10 and a metal electrode layer 20 which is disposed below the organic light-emitting diode layer 10. The metal electrode layer 20 supplies voltage and drives the organic light-emitting diode layer 10 to emit light. Thus, when an environmental incident light 30 enters into the organic light-emitting diode layer 10, an environmental reflecting light 31 is generated because of the reflecting surface 201 of the metal electrode layer 20. The environmental reflecting light 31 results in serious light reflection interference affecting the display of the conventional organic light-emitting diode display device itself.

Accordingly, there exists a need for an organic light-emitting diode display device with a function of converting to be a mirror to solve the above-mentioned problems and disadvantages.

### SUMMARY OF THE INVENTION

It is an object of the present invention to provide an organic light-emitting diode display device being a high brightness display device that can eliminate light reflection and has a function of converting the organic light-emitting diode display device to be a mirror.

In order to achieve the foregoing objects, the present invention provides an organic light-emitting diode display device with a function of converting to be a mirror including a metal electrode layer, an organic light-emitting diode layer, a phase transforming film and a polarizer. The present invention utilizes the organic light-emitting diode layer with high brightness. The phase transforming film and polarizer are disposed above the organic light-emitting diode layer in sequence, and a metal electrode layer is disposed below the organic light-emitting diode layer for supplying voltage. The phase transforming film has a retardation state of a quarter-wave phase difference that can be converted to be a retardation state with zero phase difference. The phase transforming film is in the retardation state of a quarter-wave phase difference for eliminating the light reflection of the metal electrode layer when the organic light-emitting diode layer emits the light, and the phase transforming film is in the retardation state of zero phase difference and the metal electrode layer reflects light for converting the organic light-emitting diode display device to be a mirror when the organic light-emitting diode layer does not emit light.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural sectional schematic view of an organic light-emitting diode display device in the prior art, showing the interference of an environmental reflecting light.

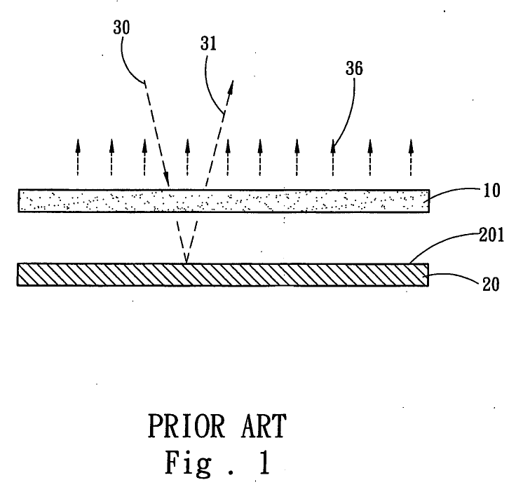

FIG. 2 is a structural sectional schematic view of an organic light-emitting diode display device according to the present invention.

FIG. 3 is a structural sectional schematic view of an organic light-emitting diode display device according to the present invention, showing the elimination of the interference of an environmental reflecting light.

FIG. 4 is a structural sectional schematic view of an organic light-emitting diode display device according to the present invention, showing the converted organic light-emitting diode display device to be a mirror.

FIG. 5 is a manufacturing flow diagram of an organic light-emitting diode display device according to the present invention.

FIG. 6 is a manufacturing flow diagram of a phase transforming film according to the present invention.

### DESCRIPTION OF THE PREFERRED EMBODIMENTS

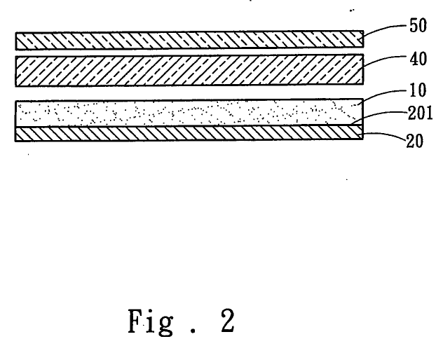

FIG. 2 depicts the structure of an organic light-emitting diode display device according to the present invention. The organic light-emitting diode display device of the present invention includes a metal electrode layer 20, an organic light-emitting diode layer 10, a phase transforming film 40 and a polarizer 50. The metal electrode layer 20 is used for supplying voltage and has a reflecting surface 201. The organic light-emitting diode layer 10 is disposed above the metal electrode layer 20, and is driven to emit light by supplying voltage of the metal electrode layer 20. The phase transforming film 40 is disposed above the organic light-emitting diode layer 10. The phase transforming film 40 has a retardation state of a quarter-wave phase difference that can be converted to be a retardation state of a zero phase difference. The polarizer 50 is disposed above the phase transforming film 40.

The phase transforming film 40 of the present invention can be a twisted nematic cell and uses the voltage to control crystal molecules to have two phase differences by utilizing crystal molecules with birefringence.

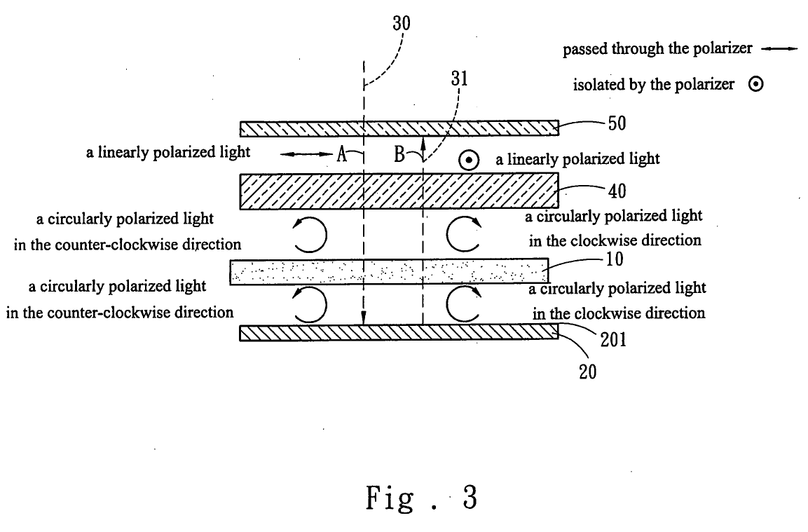

When the organic light-emitting diode layer 10 emits the light, the phase transforming film 40 is in a retardation state of a quarter-wave phase difference. As show in FIG. 3, when an environmental incident light 30 enters, it is passed through the polarizer 50 and forms a linearly polarized light in a state denoted by A. When the environmental incident light 30 is passed through the phase transforming film 40, the environmental incident light 30 is converted from the linearly polarized light in the state A to a circularly polarized light in the counter-clockwise direction. When the environmental incident light 30 is passed through the organic light-emitting diode layer 10 and is reflected by the metal electrode layer 20, the environmental incident light 30 is converted to a circularly polarized light in the clockwise direction and simultaneously becomes an environmental reflecting light 31. When the environmental reflecting light 31 is passed through the phase transforming film 40, the environmental reflecting light 31 is converted to linearly polarized light in a state B. The polarized angle difference between the linearly polarized lights of the state B and the state B is 90 degrees, and therefore the linearly polarized lights in the state B can be isolated by the polarizer 50, thereby eliminating the environmental reflecting light 31.

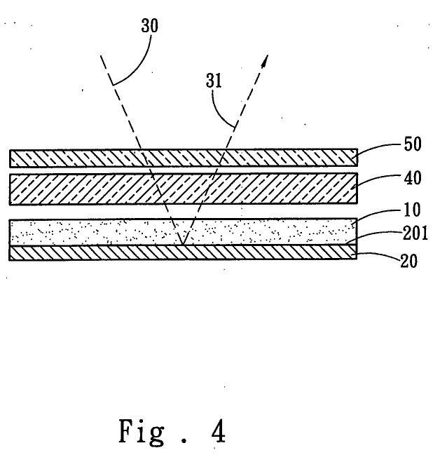

When the organic light-emitting diode layer 10 does not emit light, the phase transforming film 40 is in the retardation state of zero phase difference. Referring to FIG. 4, when an environmental incident light 30 enters, the environmental incident light 30 passes through the polarizer 50 and forms linearly polarized light. When the environmental incident light 30 is passed through the phase transforming film 40, the environmental incident light 30 does not change the state of the linearly polarized light. When the environmental incident light 30 is passed through the organic light-emitting diode layer 10 and is reflected by the reflecting surface 201 of the metal electrode layer 20, the environmental incident light 30 is formed to the linearly polarized light in the same polarized direction and simultaneously becomes an environmental reflecting light 31. The linearly polarized light of the environmental reflecting light 31 can be passed through the polarizer 50, thereby utilizing the reflection of the environmental reflecting light 31 to form a display device with a function of converting the display device to be a mirror.

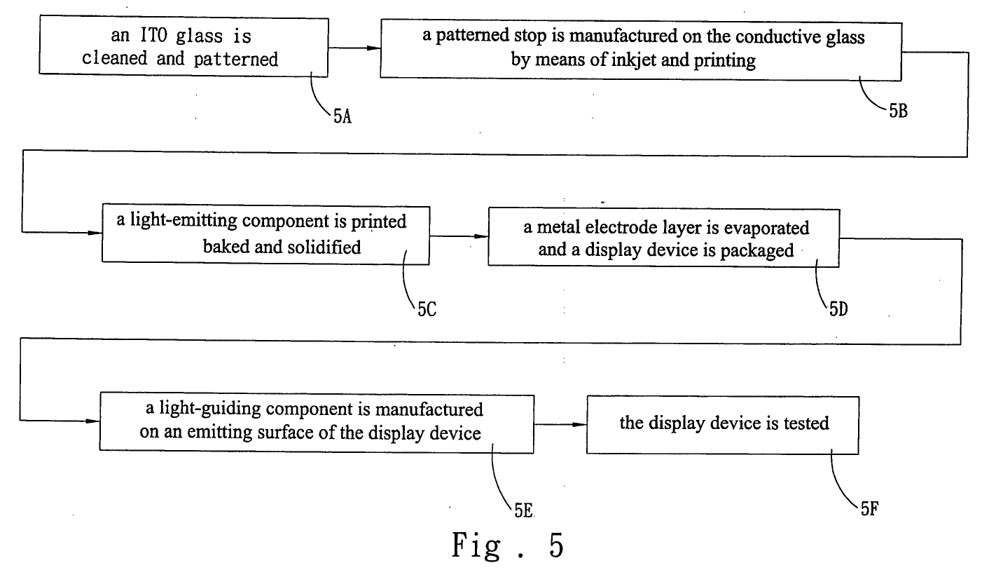

Refer to FIG. 5 for a manufacturing flow diagram of an organic light-emitting diode display device according to the present invention. In the step 5A, an electrode of specific pattern is manufactured on an ITO (Indium Tin Oxide) glass. In the step 5B, a patterned stop is manufactured on the ITO glass by means of inkjet and printing. In the step 5C, a light-emitting component (the organic light-emitting diode layer 10 is printed, baked and solidified on the ITO glass. In the step 5D, a metal electrode layer 20 evaporates on the light-emitting component, and all above-mentioned components are packaged. In the step 5E, a light-guiding component is manufactured on an emitting surface of the organic light-emitting diode display device. Finally, in the step 5F, the organic light-emitting diode display device is tested and then finished.

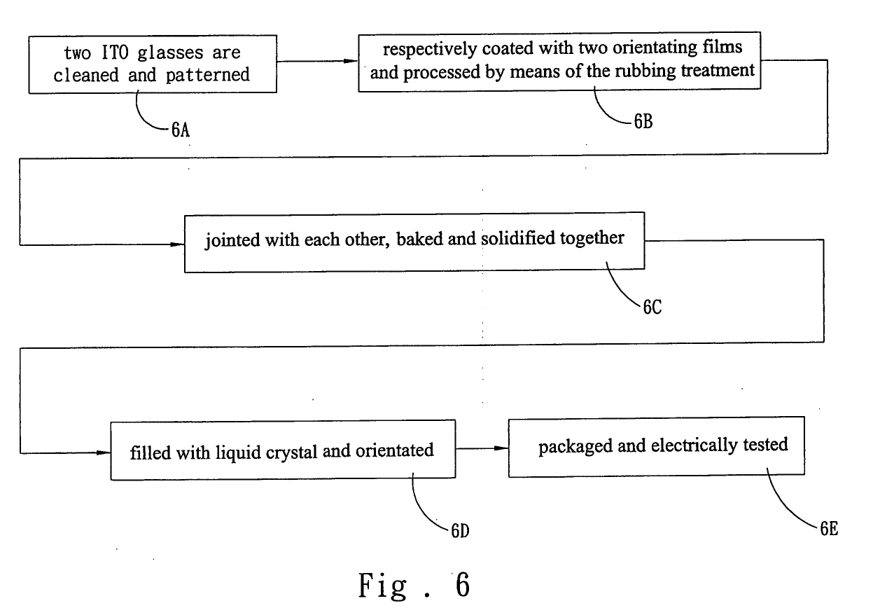

Referring to FIG. 6, a manufacturing flow diagram of a phase transforming film 40 is shown of the present invention that uses a twisted nematic cell. In the step 6A, two electrodes of the specific pattern are respectively manufactured on two ITO glasses. In the step 6B, the two ITO glasses are coated with two orientated films and processed by means of rubbing. In the step 6C, the two ITO glasses are joined together, baked and solidified. In the step 6D, the space between the two ITO glasses is filled with orientated liquid crystal. In the step 6E, two ITO glasses are packaged and electrically tested to complete the phase transforming film 40. Although the invention has been explained in relation to its preferred embodiment, it is not used to limit the invention. It is to be understood that many other possible modifications and variations can be made by those skilled in the art without departing from the spirit and scope of the invention as hereinafter claimed.

1. An organic light-emitting diode display device with a function of converting to be a mirror, comprising:
a metal electrode layer for supplying voltage and has a reflecting surface;
an organic light-emitting diode layer disposed above the metal electrode layer and driven to emit light by supplying a voltage to the metal electrode layer;
a phase transforming film disposed above the organic light-emitting diode layer and having a retardation state of a quarter-wave phase difference that can be converted to have a retardation state with zero phase difference; and
a polarizer disposed above the phase transforming film.

2. The organic light-emitting diode display device with a function of converting to be a mirror according to claim 1, wherein the phase transforming film is a twisted nematic cell.

3. The organic light-emitting diode display device with a function of converting to be a mirror according to claim 1, wherein the phase transforming film is in a retardation state with zero phase difference when the organic light-emitting diode layer does not emit light.

4. The organic light-emitting diode display device with a function of converting to be a mirror according to claim 1, wherein the phase transforming film is in a retardation state of a quarter-wave phase difference when the organic light-emitting diode layer emits light.
